(19) United States
(12) Patent Application Publication
(10) Pub. No.: US 2022/0391731 A1
(43) Pub. Date: Dec. 8, 2022

(54) AGENT DECISION-MAKING METHOD AND APPARATUS

(71) Applicant: HUAWEI TECHNOLOGIES CO., LTD., Shenzhen (CN)

(72) Inventors: Jian WANG, Hangzhou (CN); Chen XU, Hangzhou (CN); Yourui HUANGFU, Hangzhou (CN); Rong LI, Hangzhou (CN); Jun WANG, Hangzhou (CN)

(73) Assignee: HUAWEI TECHNOLOGIES CO., LTD., Shenzhen (CN)

(21) Appl. No.: 17/891,401

(22) Filed: Aug. 19, 2022

Related U.S. Application Data
(63) Continuation of application No. PCT/CN2021/074989, filed on Feb. 3, 2021.

(30) Foreign Application Priority Data
Feb. 21, 2020 (CN) 202010107928.5

(51) Int. Cl. G06N 5/04; G06K 9/62

(52) U.S. Cl. CPC G06N 5/043; G06K 9/6263; H04W 80/02

(57) ABSTRACT

This application provides an agent decision-making method and an apparatus, to improve decision-making performance of an agent. The method is applied to a communications system. The communications system includes at least two function modules. The at least two function modules include a first function module and a second function module, where the first function module is configured with a first agent, and the second function module is configured with a second agent. The method further includes the first agent obtaining related information of the second agent, and makes a decision on the first function module based on the related information of the second agent.

### CROSS-REFERENCE TO RELATED APPLICATIONS

This application is a continuation of International Application No. PCT/CN2021/074989, filed on Feb. 3, 2021, which claims priority to Chinese Patent Application No. 202010107928.5, filed on Feb. 21, 2020. The disclosures of the aforementioned applications are hereby incorporated by reference in their entireties.

### TECHNICAL FIELD

This application relates to the communications field, and more specifically, to an agent decision-making method and an apparatus.

### BACKGROUND

An existing communications system is usually divided into a plurality of function modules. For example, in a multimedia communications system for transmitting a multimedia service such as audio and videos, a module serving an audio/video encoding and decoding function and a module responsible for communication are two relatively independent modules. A system designer needs only to design and optimize modules one by one based on functions of the modules.

Similarly, a communications protocol is often divided into a plurality of layers. Each layer performs its own function and fulfills a corresponding task. For example, in a typical transmission control protocol/internet protocol (TCP/IP) model, an application layer is responsible for data communication between programs, and provides service protocols such as file transmission, email, and remote login. A transport layer may provide end-to-end reliable or unreliable communication. A network layer is responsible for address management and route selection. A data link layer handles transmission of data over a physical medium.

An optimization method in which a design of dividing a system into modules or a design of dividing a protocol into layers is used splits interaction between modules or layers, and usually, only a local optimal solution is obtained.

At present, a proposed cross-module/cross-layer optimization method is to combine a plurality of interrelated modules or layers for consideration, formulate a unified optimization problem considering multi-module/multi-layer parameters, set an optimization objective and express the optimization objective in a mathematical formula or mathematical model, and solve the optimization problem. This may allow the method to obtain a solution under the premise of considering a mutual restriction relationship between modules/layers. A modeling process of this method is often complex and needs to be simplified in many cases. As a result, a whole problem is not completely consistent with an actual problem, and only a heuristic solution can be provided, and a heuristic algorithm cannot achieve optimal performance. In addition, this method is used to model an optimization problem in a specific scenario. When a system changes, the model is no longer applicable and the optimization problem needs to be solved again. This method makes the cross-module/cross-layer optimization method very complex.

### SUMMARY

This application provides an agent decision-making method and an apparatus, to improve decision-making performance of an agent.

According to a first aspect, an agent decision-making method is provided, where the method is applied to a communications system, the communications system includes at least two function modules, and the at least two function modules include a first function module and a second function module. The first function module is configured with a first agent, and the second function module is configured with a second agent. The method includes having the first agent obtain related information of the second agent, where the first agent makes a decision on the first function module based on the related information of the second agent.

According to the foregoing technical solution, different agents may be deployed in different modules of the communications system as required. The agent may obtain related information of an agent configured in another function module other than the function module, and consider coordination between the module and the other module when making a decision, to make an optimal decision. In addition, the agent may adapt to a change of an environment by interacting with the environment, and when an environment status changes, an optimization solution model does not need to be re-formulated. Therefore, according to the technical solution provided in an embodiment of this application, decision-making performance of the agent can be improved.

In a possible implementation, the related information of the second agent includes at least one of the following information: a first evaluation parameter made by the second agent for a historical decision of the first agent, a historical decision of the second agent, a neural network parameter of the second agent, and an update gradient of the neural network parameter of the second agent.

In a possible implementation, when the first agent makes a decision on the first function module based on the related information of the second agent includes the first agent making the decision on the first function module based on related information of the first function module and/or related information of the second function module, and the related information of the second agent.

In a possible implementation, the related information of the first function module includes at least one of the following information: current environment status information of the first function module, predicted environment status information of the first function module, and a second evaluation parameter made by the first function module for the historical decision of the first agent; and the related information of the second function module includes current environment status information of the second function module and/or predicted environment status information of the second function module.

In a possible implementation, the first function module includes one of a radio link control (RLC) layer function module, a medium access control (MAC) layer function module, and a physical (PHY) layer function module; and the second function module includes at least one function module other than the first function module in the RLC layer function module, the MAC layer function module, and the PHY layer function module.

In a possible implementation, the first function module includes one of a communications function module and a source coding function module; and the second function module includes a function module other than the first function module in the communications function module and the source coding function module.

According to a second aspect, a communications apparatus is provided. The communications apparatus includes a first function module, a second function module, a first agent configured in the first function module, and a second agent configured in the second function module. The first agent includes a communications interface, configured to obtain related information of the second agent, and a processing unit (e.g., a circuit or circuits), configured to make a decision on the first function module based on the related information of the second agent.

In a possible implementation, the related information of the second agent includes at least one of the following information: a first evaluation parameter made by the second agent for a historical decision of the first agent, a historical decision of the second agent, a neural network parameter of the second agent, and an update gradient of the neural network parameter of the second agent.

In a possible implementation, the processing unit is configured to make the decision on the first function module based on related information of the first function module and/or related information of the second function module, and the related information of the second agent.

In a possible implementation, the related information of the first function module includes at least one of the following information: current environment status information of the first function module, predicted environment status information of the first function module, and a second evaluation parameter made by the first function module for the historical decision of the first agent; and the related information of the second function module includes current environment status information of the second function module and/or predicted environment status information of the second function module.

In a possible implementation, the first function module includes one of a radio link control (RLC) layer function module, a medium access control (MAC) layer function module, and a physical (PHY) layer function module; and the second function module includes at least one function module other than the first function module in the RLC layer function module, the MAC layer function module, and the PHY layer function module.

In a possible implementation, the first function module includes one of a communications function module and a source coding function module; and the second function module includes a function module other than the first function module in the communications function module and the source coding function module.

According to a third aspect, a network device is provided. The network device includes a memory, configured to store executable instructions; and a processor, configured to invoke and run the executable instructions in the memory, to perform the method in the first aspect or any one of the possible implementations of the first aspect.

According to a fourth aspect, a computer-readable storage medium is provided, where the computer-readable storage medium stores program instructions, and when the program instructions are run by a processor, the method in the first aspect or any one of the possible implementations of the first aspect is implemented.

According to a fifth aspect, a computer program product is provided, where the computer program product includes computer program code, and when the computer program code is run on a computer, the method in the first aspect or any one of the possible implementations of the first aspect is implemented.

### BRIEF DESCRIPTION OF DRAWINGS

FIG. 1 is a schematic diagram of a reinforcement learning training method according to an embodiment;

FIG. 2 is a schematic diagram of a multilayer perceptron according to an embodiment;

FIG. 3 is a schematic diagram of loss function optimization according to an embodiment;

FIG. 4 is a schematic diagram of gradient backpropagation according to an embodiment;

FIG. 5 is a schematic flowchart of an agent decision-making method according to an embodiment of this application;

FIG. 6 is a schematic block diagram of an implementation of an agent decision-making method according to an embodiment of this application;

FIG. 7 is a schematic block diagram of another implementation of an agent decision-making method according to an embodiment of this application;

FIG. 8 is a schematic block diagram of another implementation of an agent decision-making method according to an embodiment of this application;

FIG. 9 is a schematic block diagram of another implementation of an agent decision-making method according to an embodiment of this application;

FIG. 10 is a schematic block diagram of a communications apparatus according to an embodiment of this application; and

FIG. 11 is a schematic block diagram of a network device according to an embodiment of this application.

### DESCRIPTION OF EMBODIMENTS

The following describes the technical solutions of this application with reference to the accompanying drawings.

Embodiments of this application may be applied to various communications systems, for example, a narrowband internet of things (Narrow Band-Internet of Things, NB-IoT) system, a global system for mobile communications (GSM), an enhanced data rate for GSM evolution (EDGE) system, a wideband code division multiple access (WCDMA) system, a code division multiple access 2000 (CDMA2000) system, a time division-synchronous code division multiple access (TD-SCDMA) system, a long term evolution (LTE) system, a satellite communications system, a 5th generation (5G) system, and a new communications system emerging in the future.

A terminal device in embodiments of this application may include various handheld devices having a wireless communications function, vehicle-mounted devices, wearable devices, computing devices, or other processing devices connected to wireless modems. A terminal may be a mobile station (MS), a subscriber unit, user equipment (UE), a cellular phone, a smartphone (smart phone), a wireless data card, a personal digital assistant (PDA) computer, a tablet computer, a wireless modem, a handheld device, a laptop computer, a machine type communication (MTC) terminal, or the like.

An existing communications system is usually divided into a plurality of function modules. For example, in a multimedia communications system for transmitting a multimedia service such as audio and videos, a module serving an audio/video encoding and decoding function and a module responsible for communication are two relatively independent modules. A system designer needs only to design and optimize modules one by one based on functions of the modules. For example, for an audio/video encoding and decoding module, only how to encode and decode an audio/video stream needs to be designed, that is, a used standard, frame rate, bit rate, resolution, and the like need to be designed. For a communications module, only a communications mode needs to be designed, that is, a used standard, communications resource allocation, channel coding, a modulation scheme, and the like need to be designed.

Similarly, a communications protocol is often divided into a plurality of layers. Each layer performs its own function and fulfills a corresponding task. For example, in a typical TCP/IP four-layer model, an application layer is responsible for data communication between programs, and provides service protocols such as file transmission, email, and remote login. A transport layer is responsible for reliable or unreliable end-to-end communication. A network layer is responsible for address management and route selection. A data link layer is responsible for transmission of data over a physical medium.

A design of dividing a system into modules or a design of dividing a protocol into layers reduces implementation complexity, allows each module/layer to focus on a specific task, and facilitates optimization for each module/layer. However, an interaction relationship between modules or layers is split, and usually, only a local optimal solution is obtained.

At present, a cross-module/cross-layer optimization method is provided, to combine a plurality of interrelated modules or layers for consideration, formulate a unified optimization problem considering a multi-module/multi-layer parameter, set an optimization objective and express the optimization objective in a mathematical formula or mathematical model, and solve the optimization problem, to obtain a solution considering a mutual restriction relationship between modules/layers. A modeling process of this method is often complex and needs to be simplified in many cases. As a result, a whole problem is not completely consistent with an actual problem, and only a heuristic solution can be provided, and a heuristic algorithm cannot achieve optimal performance. In addition, this method is used to model an optimization problem in a specific scenario. When a system changes, the model is no longer applicable and the optimization problem needs to be solved again. This method makes the cross-module/cross-layer optimization method very complex.

In view of this, an embodiment of this application provides an agent decision-making method, to improve decision-making performance of an agent.

Generally, in the field of artificial intelligence, an agent refers to a software or hardware entity capable of autonomous activities and autonomous decisions, and an environment refers to an external condition outside the agent. For a communications system, the agent is a decision-making software or hardware entity, and the environment is a general term of external conditions outside the software or hardware entity.

To ease of understanding the method provided in this application, a decision-making model, reinforcement learning, and a neural network are first described.

The decision-making model may be understood as a model for analyzing a decision-making problem. Radio resource scheduling belongs to a decision-making problem, and a decision-making model may be constructed for the decision-making problem.

A Markov decision process (MDP) is a mathematical model for analyzing a decision-making problem. It is assumed that an environment has a Markov property. That is, a conditional probability distribution of a future status of the environment depends on only a current status. A decision maker periodically observes a status of the environment, makes a decision based on the current status of the environment, and obtains a new status and a reward after interacting with the environment.

Radio resource scheduling plays a vital role in a cellular network, and the essence of the radio resource scheduling is to allocate a resource such as an available radio spectrum based on current channel quality, a quality of service (QoS) requirement, and the like of each user. In this application, a radio resource scheduling process may be established as an MDP. The MDP is solved through reinforcement learning in an artificial intelligence (AI) technology. An agent decision-making method is provided.

The reinforcement learning is a machine learning field, and can be used to solve the Markov decision process. The reinforcement learning emphasizes that the agent can obtain a maximum expected benefit and learns an optimal behavior by interacting with the environment. The agent obtains the current status by observing the environment, makes a decision on an action according to a specific rule (policy), and feeds back the action to the environment. The environment feeds back a reward or a punishment obtained after the action is executed to the agent. Through a plurality of iterations, the agent learns to make an optimal decision based on an environment status.

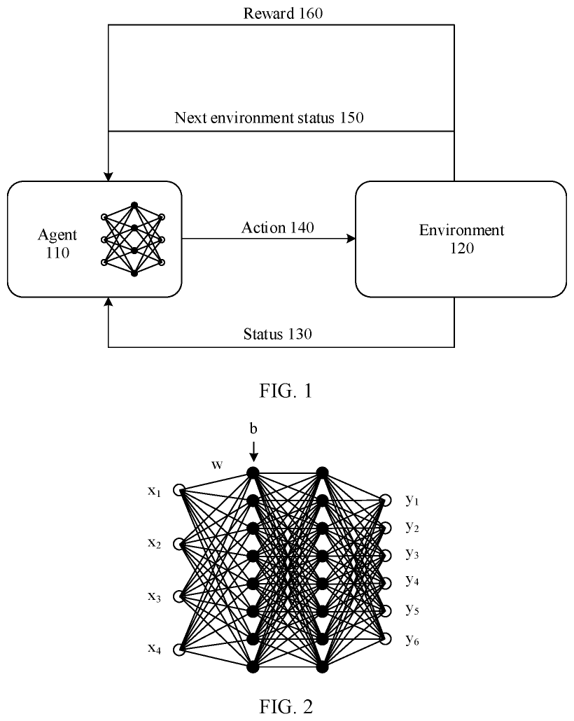

FIG. 1 is a schematic diagram of a reinforcement learning training method. An agent 110 includes a decision-making policy, where the decision-making policy may be an algorithm represented by a formula, or may be a neural network, as shown in FIG. 1. Training steps of the agent in reinforcement learning are as follows:

First, the decision-making policy of the agent 110 is initialized. The initialization refers to initialization of a parameter in the neural network.

Step 2: The agent 110 obtains an environment status 130.

Step 3: The agent 110 obtains a decision-making action 140 by using a decision-making policy π based on the input environment status 130, and notifies an environment 120 of the decision-making action 140.

Step 4: The environment 120 executes the decision-making action 140, where the environment status 130 transits into a next environment status 150; and the agent 110 obtains a reward 160 corresponding to the decision-making policy π.

Step 5: The agent 110 obtains the reward 160 corresponding to the decision-making policy π and the next environment status 150, and updates the decision-making policy based on the input environment status 130, the decision-making action 140, the reward 160 corresponding to the decision-making policy π, and the next environment status 150. An objective of the update is to maximize a reward or minimize a punishment.

Step 6: If a training termination condition is not met, return to step 3. If the training termination condition is met, terminate training.

It should be understood that the foregoing training steps may be performed online or offline. If the foregoing training steps are performed offline, data in each iteration (for example, the input environment status 130, the decision-making action 140, the reward 160 corresponding to the decision-making policy, and the next environment status 150) is put into an experience buffer for training.

The training termination condition generally means that during training of the agent, in the fifth step, the reward is greater than a preset threshold or the punishment is less than a preset threshold. Alternatively, a quantity of training iterations may be specified in advance. That is, after the preset quantity of iterations is reached, the training is terminated. Alternatively, whether the training is terminated may be controlled based on performance of a system. For example, performance indicators of the system (for example, a throughput, a packet loss rate, a latency, and fairness in a communications system) reach a preset threshold.

A trained agent enters an inference phase and performs the following steps:

Step 1: The agent obtains an environment status.

Step 2: The agent obtains a decision-making action by using a decision-making policy based on the input environment status, and notifies the environment of the decision-making action.

Step 3: The environment executes the decision-making action, where the environment status transits into a next environment status.

Step 4: Return to step 1.

It can be learned from the foregoing description that the trained agent no longer considers a reward corresponding to a decision, and needs to make a decision based on only the environment status according to the policy of the trained agent.

In actual use, the training steps and the inference steps of the agent are alternately performed. That is, training is performed for a period of time, and inference starts after the training termination condition is reached. After the inference is performed for a period of time, a system environment changes, and an original trained policy may no longer be applicable. In this case, the training process needs to be restarted.

Deep reinforcement learning is obtained by combining the reinforcement learning and deep learning. The deep reinforcement learning still conforms to a framework of interaction between the agent and the environment in the reinforcement learning. A difference is that in the agent, a deep neural network is used to make a decision. A method for training the agent through the deep reinforcement learning is also applicable to technical solutions protected in embodiments of this application.

A fully-connected neural network is also referred to as a multilayer perceptron (MLP). One MLP includes one input layer (on the left side), one output layer (on the right side), and a plurality of hidden layers (in the middle). Each layer includes several nodes, and the nodes are referred to as neurons. Neurons at two adjacent layers are connected to each other, as shown in FIG. 2.

Considering the neurons at the two adjacent layers, an output h of a neuron at a lower layer is obtained through a weighted sum of all neurons x at an upper layer that are connected to the neuron at the lower layer and inputting the weighted sum into an activation function. The operations described above may be expressed by using a matrix as follows:

h=f(wx+b)

w represents a weight matrix, b represents an offset vector, and f represents the activation function. In this case, an output of the neural network may be recursively expressed as follows:

y=fₙ(wₙfₙ₋₁( . . . )+bₙ)

Briefly, the neural network may be understood as a mapping relationship from an input data set to an output data set. The neural network is usually initialized at random, and a process of obtaining the mapping relationship by using existing data is referred to as training of the neural network.

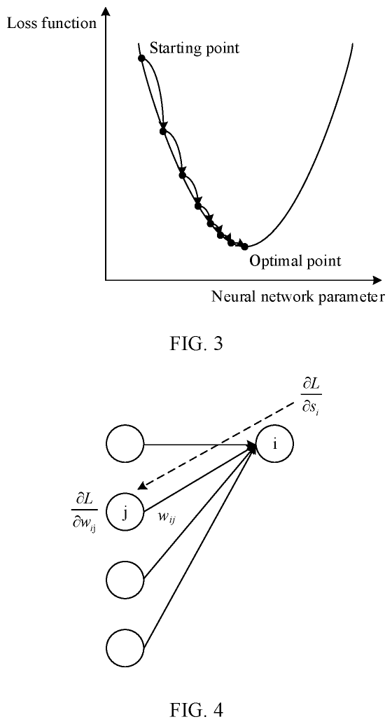

A specific training manner is to evaluate an output result of the neural network by using a loss function, and back propagate an error. In this way, w and b can be iteratively optimized by using a gradient descent method, until the loss function reaches a minimum value, as shown in FIG. 3.

A gradient descent process may be expressed as follows:

$$θ ← θ - η \frac{\partial L}{\partial θ}$$

θ represents to-be-optimized parameters (for example, w and b), L represents the loss function, and η represents a learning rate, which controls a gradient descent step.

A backpropagation process uses a chain rule for obtaining a partial derivative. To be specific, a gradient of a parameter of a previous layer may be recursively calculated based on a gradient of a parameter of a followed layer. As shown in FIG. 4, a formula may be expressed as follows:

$$\frac{\partial L}{\partial {w}_{ij}} = \frac{\partial L}{\partial {s}_{i}} \frac{\partial {s}_{i}}{\partial {w}_{ij}}$$

wᵢⱼ represents a weight of connecting a node j to a node i, and sᵢ represents a weighted sum of inputs on the node i.

According to the reinforcement learning training method, the agent can continuously improve its own parameter configuration by interacting with the environment (that is, obtaining the environment status, making the decision, and obtaining the decision reward and the next environment status), to make a better decision. In addition, due to interaction with the environment and an iterative self-improvement mechanism, the agent can track a change of the environment. However, in a conventional decision-making algorithm, after a decision is made, a decision reward given by the environment cannot be obtained. Therefore, self-improvement cannot be implemented through interaction with the environment. In addition, when the environment status changes, a current decision-making algorithm is no longer applicable, and a mathematical model needs to be re-formulated.

According to the agent decision-making method provided in some embodiments of this application, the agent is trained through reinforcement learning, and then a trained agent is used to make a decision.

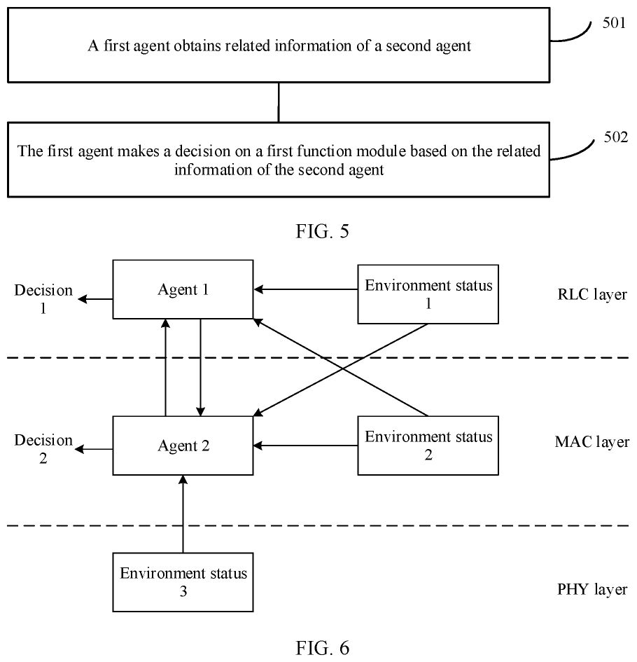

FIG. 5 is a schematic diagram of an agent decision-making method according to an embodiment of this application. The agent decision-making method 500 is applied to a communications system. The communications system includes at least two function modules, and the at least two function modules include a first function module and a second function module.

The first function module is configured with a first agent, and the second function module is configured with a second agent. The method 500 includes the following steps.

501: The first agent obtains related information of the second agent.

Specifically, the related information of the second agent includes at least one of the following information: a first evaluation parameter made by the second agent for a historical decision of the first agent, a historical decision of the second agent, a neural network parameter of the second agent, and an update gradient of the neural network parameter of the second agent.

The first evaluation parameter made by the second agent for the historical decision of the first agent may be determined based on a matching degree between a requirement of the function module in which the second agent is located and a capability supply of the function module in which the first agent is located.

The historical decision of the second agent may include a previous decision of the second agent, or may include all decisions that have been made by the second agent. This is not limited in embodiments of this application.

Information of the historical decision of the second agent may be derived by using the neural network parameter of the second agent or the update gradient of the neural network parameter of the second agent.

502: The first agent makes a decision on the first function module based on the related information of the second agent.

Optionally, in an implementation, the first agent makes the decision on the first function module based on related information of the first function module and/or related information of the second function module, and the related information of the second agent.

Specifically, the related information of the first function module includes at least one of the following information: current environment status information of the first function module, predicted environment status information of the first function module, and a second evaluation parameter made by the first function module for the historical decision of the first agent; and the related information of the second function module includes current environment status information of the second function module and/or predicted environment status information of the second function module. The second evaluation parameter may be a reward or a punishment.

The predicted environment status information of the first function module may be determined by the first agent based on the current environment status information or historical environment status information of the first function module. The predicted environment status information of the second function module may be determined by the first agent based on the current environment status information or historical environment status information of the second function module, or may be determined by the second agent based on the current environment status information or historical environment status information of the second function module. If the predicted environment status information of the second function module is determined by the second agent, when the first agent interacts with the second agent, the predicted environment status information of the second function module is transited to the first agent.

In other words, when the first agent makes the decision on the first function module, in addition to the related information of the second agent, not only the current environment status information of the first function module and/or the predicted environment status information of the first function module, but also the current environment status information of the second function module and/or the predicted environment status information of the second function module may be input into a neural network in the first agent. In the agent decision-making method provided in embodiments of this application, a training process of the agent and an inference process of the agent are alternately performed. In a training process of reinforcement learning, corresponding reward information or punishment information may be obtained after a decision-making action is executed. Therefore, second evaluation parameter information made by the first function module on the historical decision of the first agent may be further input into the first agent.

The first function module and the second function module are function modules that are associated with each other. The first function module and the second function module may be different function modules of a same communications device in the communications system, or may be different function modules of different communications devices in the communications system. For example, both the first function module and the second function module are located in a first device. Alternatively, the first function module is located in a first device, and the second function module is located in a second device. It should be understood that the first device and the second device may be devices having a same function, or may be devices having different functions.

There may be one, two, or even more second function modules. If there are two second function modules, the first agent may obtain related information of the two second function modules in a decision-making process.

In the technical solution provided in embodiments of this application, different agents may be deployed in different modules of the communications system as required. The agent may obtain related information of an agent configured in another function module other than the function module, and consider coordination between the module and the other module when making a decision, to make an optimal decision. In addition, the agent may adapt to a change of an environment by interacting with the environment, and when an environment status changes, an optimization solution model does not need to be re-formulated. Therefore, according to the technical solution provided in embodiments of this application, decision-making performance of the agent can be improved.

Optionally, in an embodiment, the first function module may be one of a radio link control (RLC) layer function module, a medium access control (MAC) layer function module, and a physical (PHY) layer function module. The second function module may be at least one function module other than the first function module in the RLC layer function module, the MAC layer function module, and the PHY layer function module. For example, if the first function module is the medium access control (MAC) layer function module, the second function module may be the radio link control (RLC) layer function module or the physical (PHY) layer function module.

Optionally, in another embodiment, the first function module may be one of a communications function module and a source coding function module. The second function module may be a function module other than the first function module in the communications function module and the source coding function module.

To more specifically describe the agent decision-making method provided in embodiments of this application, specific implementations are used for detailed description.

### Implementation 1

As shown in FIG. 6, in a cellular network, a MAC layer determines a radio transmission resource scheduling scheme based on buffer information (a size of a to-be-sent data packet, a waiting time, and the like) that is in a data packet queue and that are obtained from an RLC layer, a channel condition, a historical scheduling status, and the like. The RLC layer maintains the data packet queue (a packet loss, copy and retransmission, and the like) based on a QoS requirement of a service and a lower-layer transmission status.

An agent may be deployed at each of the RLC layer and the MAC layer. An environment status 1 input into an agent 1 at the RLC layer includes a QoS requirement of a service and a data packet queue status (a queue length, a waiting time, and an arrival rate). An environment status 2 input into an agent 2 at the MAC layer includes historical scheduling status statistics (a historical average throughput, a quantity of scheduled times, and the like) at the MAC layer. An environment status 3 input at a PHY layer includes radio channel quality (which is usually input in a form of an estimated throughput).

In addition, information interaction is further performed between the two agents deployed at the two layers. Interaction information may be an output of a neural network (a historical decision of the agent), a neural network parameter, and/or an update gradient of the neural network parameter in a training process of the neural network. The interaction information may alternatively be a parameter of an evaluation on quality of a decision made by another agent. The output of the neural network, the neural network parameter, the update gradient of the neural network parameter in the training process of the neural network are all related parameters of the neural network, and are convenient to be obtained. A parameter of an evaluation performed by an agent at a current layer on quality of a decision made by an agent at another layer may be determined based on a matching degree between a requirement of the current layer and a capability supply of the other layer. For example, the RLC layer estimates a data transmission rate requirement based on the environment status 1 and performance indicator requirements such as a system latency and a packet loss rate at the RLC layer. An actual data transmission rate is determined by the MAC layer. When there is a small difference between the data transmission rate provided by the MAC layer and the rate requirement at the RLC layer, the agent at the RLC layer makes a high evaluation on the agent at the MAC layer. Otherwise, the agent at the RLC layer makes a low evaluation on the agent at the MAC layer. Similarly, the MAC layer may estimate, based on the environment status 2 at the MAC layer and the environment status 3 at the PHY layer, a data packet traffic requirement that meets a system performance indicator requirement. Actual data packet traffic depends on a maintenance status of a data packet buffer at the RLC layer. When there is a large difference between the actual data packet traffic and data packet traffic required by a system performance indicator, the agent at the MAC layer makes a low evaluation on the agent at the RLC layer. Otherwise, the agent at the MAC layer makes a high evaluation on the agent at the RLC layer.

In a training and inference process of the agent, three groups of parameters, such as an environment status, a decision-making action, and a reward, need to be determined. The reward usually uses an overall performance indicator of a system. For example, in a communications system, the reward may be a function (for example, a weighted sum) of system performance indicators such as a throughput, fairness, a packet loss rate, and a latency. Different agents have different environment statuses and different decision-making actions.

Specifically, an environment status input into a neural network of the agent 1 at the RLC layer includes the environment status 1, the environment status 2, and interaction information sent by the agent 2. A decision 1 output by the neural network includes a data packet discarding decision, a data packet duplication and retransmission decision, a data packet queue-related decision, and the like.

An environment status input into a neural network of the agent 2 at the MAC layer includes the environment status 1, the environment status 2, the environment status 3, and interaction information sent by the agent 1. An output decision 2 includes a radio transmission resource scheduling scheme, a modulation and coding scheme, and the like.

It should be noted that the environment status 2 may be partially input into the agent 1, and the environment status 1 may be partially input into the agent 2. For example, the QoS requirement of the service in the environment status 1 is not input into the agent 2.

### Implementation 2

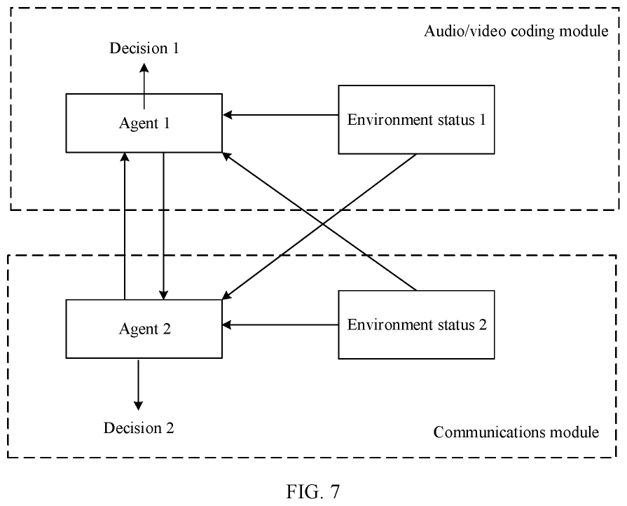

As shown in FIG. 7, in a multimedia communications system, for example, in a cellular network that transmits an audio/video stream service, an audio/video coding module needs to determine parameters such as a bit rate, a frame rate, and resolution for audio/video coding based on factors such as a requirement of a receive end, a software and hardware capability of the audio/video coding module, and communications link quality. A communications module needs to determine solutions such as radio resource usage, channel coding, and a modulation scheme based on factors such as a status (a size, a QoS requirement, and the like) of to-be-transmitted data, and radio channel quality. A decision of an audio/video coding module affects the status of the to-be-transmitted data received by the communications module. On the other hand, a decision of the communications module also affects communications link quality information that can be obtained by the audio/video coding module. An agent may be deployed in each of two modules. Interaction and coordination are performed between the modules based on a multi-agent reinforcement learning framework, to adapt to an environment change.

An agent may be deployed in each of the audio/video coding module and the communications module. An environment status 1 input into an agent 1 in the audio/video coding module includes a request of a receive end, a software and hardware capability of the agent 1, a data packet buffer status, and the like. An environment status 2 input into an agent 2 in the communications module includes radio channel quality, and the like.

In addition, information interaction is further performed between two agents deployed at two layers. Interaction information may include an output of a neural network, a neural network parameter, and/or an update gradient of the neural network parameter in a training process of the neural network. The interaction information may alternatively be a parameter of an evaluation on quality of a decision made by another agent. The output of the neural network, the neural network parameter, and/or the update gradient of the neural network parameter in the training process of the neural network are all related parameters of the neural network, and are convenient to be obtained. A parameter of an evaluation performed by an agent at a current layer on quality of a decision made by an agent at another layer may be determined based on a matching degree between a requirement of the current layer and a capability supply of the other layer. For example, the agent 1 estimates a communications capability (for example, a data transmission rate, a latency, and a packet loss rate) requirement based on the environment status 1 and a system performance indicator requirement of the audio/video coding module. When there is a large difference between a capability provided by the communications module and the estimated requirement, the agent 1 makes a low evaluation on the agent 2. Otherwise, the agent 1 makes a high evaluation on the agent 2. Similarly, the agent 2 estimates a data traffic requirement based on the environment status 2 and a system performance indicator requirement of the communications module. When there is a large difference between data traffic provided by the audio/video coding module and the estimated requirement, the agent 2 makes a low evaluation on the agent 1. Otherwise, the agent 2 makes a high evaluation on the agent 1.

Similar to the implementation 1, in a training and inference process of the agent, three groups of parameters, such as an environment status, a decision-making action, and a reward, need to be determined. The reward usually uses an overall performance indicator of a system. For example, in a multimedia communications system, the reward may be a function related to a user parameter (QoE). Different agents have different environment statuses and different decision-making actions.

Specifically, an environment status input into a neural network of the agent 1 in the audio/video coding module includes the environment status 1, the environment status 2, and interaction information sent by the agent 2. A decision 1 output by the neural network includes a coding policy, a bit rate, a frame rate, resolution, and the like used for audio/video coding.

An environment status input into a neural network of the agent 2 in the communications module includes the environment status 1, the environment status 2, and interaction information sent by the agent 1. An output decision 2 includes a radio transmission resource scheduling policy, a modulation and coding scheme, and the like.

Similarly, the environment status in each module may be partially or fully input into the agent in the other module.

### Implementation 3

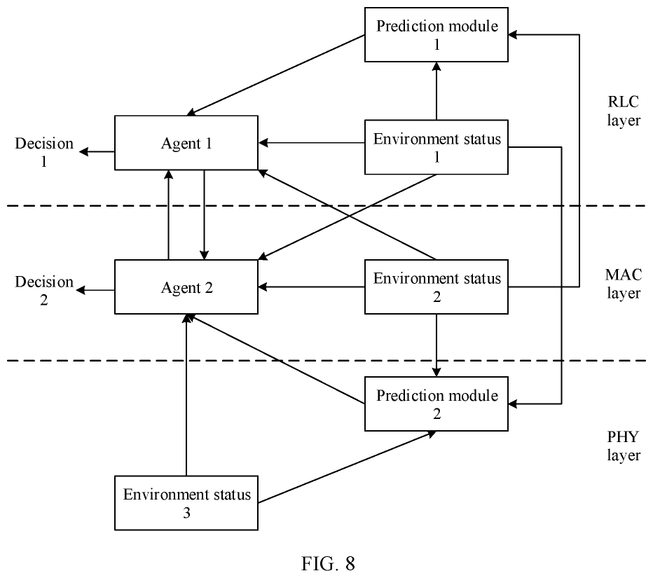

As shown in FIG. 8, in a decision-making method based on multi-agent reinforcement learning (MARL) in the implementation 1, a prediction module may be further added to each of an RLC layer and a MAC layer, to perform prediction based on an environment status. A prediction module 1 at the RLC layer may predict a future data packet queue status based on a data packet queue status in an environment status 1, and may predict a future MAC layer scheduling scheme based on historical scheduling status statistics at the MAC layer in an environment status 2. Similarly, a prediction module 2 at the MAC layer may also perform similar prediction. In addition, the prediction module 2 may further predict future radio channel quality information based on radio channel quality information at the PHY layer. Each prediction module inputs a prediction result into an agent at each layer, to help the agent make a decision.

The prediction module 1 and the prediction module 2 predict a future status by using time correlation between traffic data and a radio channel based on historical status data. As shown in FIG. 8, the prediction module 1 predicts a future data packet queue status and a scheduling scheme based on a historical system status 1 and a historical system status 2. The prediction module 2 predicts a future data packet queue status, a scheduling decision, and a radio channel status based on the historical system status 1, the historical system status 2, and a historical system status 3. A benefit of the agent includes long-term performance statistics parameters (for example, fairness and a packet loss rate in a communications system). Therefore, prediction of a future system status can help the agent consider the future when making a decision, to improve long-term performance.

It should be understood that a prediction function of the prediction module may be implemented by using a neural network in the agent. That is, the prediction module may be a part of the neural network included in the agent. In other words, the prediction module may be a part of the agent. The prediction module may alternatively be a module independent of the agent.

When the prediction module is used, prediction data is added to an input parameter of the neural network in the agent. Therefore, an input dimension increases in comparison with a case in which there is no prediction module in the same scenario.

### Implementation 4

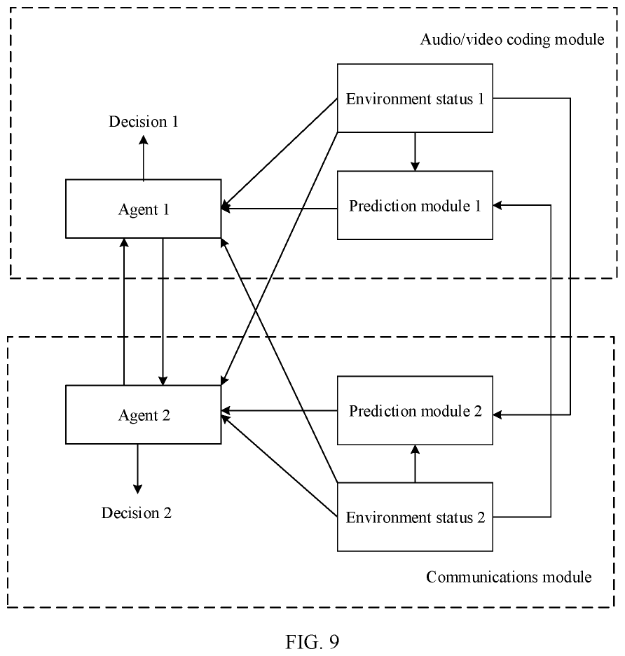

As shown in FIG. 9, in a cross-module joint decision-making solution in the implementation 2, a prediction module may be further added to each module. A prediction module 1 in an audio/video coding module may predict a future data packet queue status based on a data packet buffer status in an environment status 1, and may predict future radio channel quality based on historical radio channel quality in an environment status 2. Similarly, a prediction module 2 in a communications module may also perform same prediction. Each prediction module inputs a prediction result into an agent in the module in which the prediction module is located, to help the agent make a better decision.

The prediction module 1 and the prediction module 2 predict a future status by using time correlation between traffic data and a radio channel based on historical status data. As shown in FIG. 9, the prediction module 1 predicts a future data packet queue status and a radio channel status based on a historical system status 1 and a historical system status 2. The prediction module 1 predicts the future data packet queue status and the radio channel status based on the historical system status 1 and the historical system status 2. A benefit of the agent includes a long-term performance statistics parameter (for example, a long-term QoE evaluation in a multimedia communications system). Therefore, prediction of a future system status can help the agent consider the future when making a decision.

It should be understood that a prediction function of the prediction module may be implemented by using a neural network in the agent. That is, the prediction module may be a part of the neural network included in the agent. In other words, the prediction module may be a part of the agent. The prediction module may alternatively be a module independent of the agent.

When the prediction module is used, prediction data is added to an input parameter of the neural network in the agent. Therefore, an input dimension increases in comparison with a case in which there is no prediction module in the same scenario.

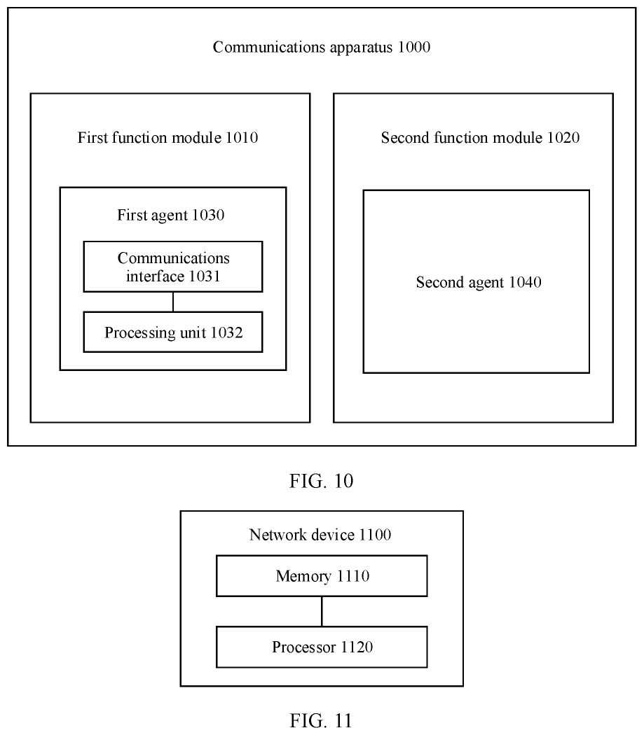

An embodiment of this application provides a communications apparatus 1000. FIG. 10 is a schematic block diagram of the communications apparatus 1000 according to an embodiment of this application. The communications apparatus 1000 includes:

a first function module 1010;

a second function module 1020;

a first agent 1030 configured in the first function module; and

a second agent 1040 configured in the second function module, where

the first agent 1030 includes:

a communications interface 1031, configured to obtain related information of the second agent 1040; and

a processing unit 1032 (e.g., a circuit or circuits), configured to make a decision on the first function module 1010 based on the related information of the second agent 1040.

Optionally, the related information of the second agent includes at least one of the following pieces of information: a first evaluation parameter made by the second agent for a historical decision of the first agent, a historical decision of the second agent, a neural network parameter of the second agent, and an update gradient of the neural network parameter of the second agent.

Optionally, the processing unit 1032 is configured to make the decision on the first function module based on related information of the first function module and/or related information of the second function module, and the related information of the second agent.

Optionally, the related information of the first function module includes at least one of the following pieces of information: current environment status information of the first function module, predicted environment status information of the first function module, and a second evaluation parameter made by the first function module for the historical decision of the first agent; and the related information of the second function module includes current environment status information of the second function module and/or predicted environment status information of the second function module.

Optionally, in an embodiment, the first function module includes one of a radio link control (RLC) layer function module, a medium access control (MAC) layer function module, and a physical (PHY) layer function module; and the second function module includes at least one function module other than the first function module in the RLC layer function module, the MAC layer function module, and the PHY layer function module.

Optionally, in another embodiment, the first function module includes one of a communications function module and a source coding function module; and the second function module includes a function module other than the first function module in the communications function module and the source coding function module.

An embodiment of this application provides a network device 1100. FIG. 11 is a schematic block diagram of the network device according to embodiments of this application. The network device 1100 includes:

a memory 1110, configured to store executable instructions; and

a processor 1120, configured to invoke and run the executable instructions in the memory 1110, to implement the method in embodiments of this application.

The foregoing processor may be an integrated circuit chip, and has a signal processing capability. In an implementation process, the steps in the foregoing method embodiments can be implemented by a hardware integrated logical circuit in the processor, or by using instructions in a form of software. The foregoing processor may be a general-purpose processor, a digital signal processor (DSP), an application-specific integrated circuit (ASIC), a field programmable gate array (FPGA), another programmable logic device, a discrete gate, a transistor logic device, or a discrete hardware component. The processor may implement or perform the methods, steps, and logical block diagrams that are disclosed in embodiments of this application. The general-purpose processor may be a microprocessor, or may be any conventional processor or the like. Steps of the methods disclosed with reference to embodiments of this application may be directly performed and completed by a hardware decoding processor, or may be performed and completed by using a combination of hardware and software modules in a decoding processor. The software module may be located in a storage medium mature in the art, such as a random access memory, a flash memory, a read-only memory, a programmable read-only memory, an electrically erasable programmable memory, a register, or the like. The storage medium is located in the memory, and the processor reads information in the memory and completes the steps in the foregoing method in combination with hardware of the processor.

The foregoing memory may be a volatile memory or a non-volatile memory, or may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), used as an external cache. RAMs in many forms are available by way of examples but not limitations, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DR RAM).

It should be understood that the memory may be integrated into the processor, or the processor and the memory may be integrated into a same chip, or may be separately located on different chips and connected in an interface coupling manner. This is not limited in embodiments of this application.

Embodiments of this application further provide a computer-readable storage medium. The computer-readable storage medium stores computer instructions used to implement the method in the foregoing method embodiments. When the computer program is executed by a computer, the computer is enabled to implement the method in the foregoing method embodiments.

Embodiments of this application further provides a computer program product including instructions. When the instructions are executed by a computer, the computer is enabled to implement the method in the foregoing method embodiments.

In addition, the term “and/or” in this application merely indicates an association relationship for describing associated objects, and indicates that three relationships may exist. For example, A and/or B may indicate the following three cases: Only A exists, both A and B exist, and only B exists. In addition, the character “/” in this specification generally indicates that the associated objects are in an “or” relationship. In this application, the term “at least one” may represent “one” and “two or more”. For example, at least one of A, B, and C may represent the following seven cases: Only A exists, only B exists, only C exists, both A and B exist, both A and C exist, both C and B exist, A, B, and C all exist.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each specific application, but such implementation should not be considered beyond the scope of this application.

A person skilled in the art may clearly learn that, for the purpose of convenient and brief description, for a specific working process of the foregoing system, apparatus, and unit, refer to a corresponding process in the foregoing method embodiments, and details are not described herein again.

In several embodiments provided in this application, it should be understood that the disclosed system, apparatus, and method may be implemented in other manners. For example, the described apparatus embodiments are merely examples. Division into the units is merely logical function division. In actual implementation, there may be another division manner. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electrical form, a mechanical form, or another form.

The units described as separate parts may or may not be physically separate, and parts displayed as units may or may not be physical units, may be located in one position, or may be distributed on a plurality of network units. A part or all of the units may be selected based on actual requirements to achieve the objectives of the solutions in the embodiments.

In addition, functional units in embodiments of this application may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this application essentially, or the part contributing to the current technology, or a part of the technical solutions may be implemented in a form of a software product. The software product is stored in a storage medium, and includes several instructions for instructing a computer device (which may be a personal computer, a server, or a network device) to perform all or a part of the steps of the methods described in the embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An agent decision-making method, applied to a communications system, the communications system comprising at least two function modules, the at least two function modules comprising a first function module configured with a first agent and a second function module configured with a second agent, the method comprising:
obtaining, by the first agent, related information of the second agent; and
making, by the first agent, a decision on the first function module based on the related information of the second agent.

2. The method according to claim 1, wherein the related information of the second agent comprises at least one of the following information:
a first evaluation parameter made by the second agent for a historical decision of the first agent,
a historical decision of the second agent,
a neural network parameter of the second agent, or
an update gradient of the neural network parameter of the second agent.

3. The method according to claim 1, wherein the making, by the first agent, the decision on the first function module based on the related information of the second agent comprises:
making, by the first agent, the decision on the first function module based on at least one of related information of the first function module or related information of the second function module; and
the related information of the second agent.

4. The method according to claim 3, wherein:
the related information of the first function module comprises at least one of the following information: current environment status information of the first function module,
predicted environment status information of the first function module, or
a second evaluation parameter made by the first function module for the historical decision of the first agent; and
the related information of the second function module comprises at least one of current environment status information of the second function module or predicted environment status information of the second function module.

5. The method according to claim 1, wherein:
the first function module comprises one of a radio link control (RLC) layer function module, a medium access control (MAC) layer function module, and a physical (PHY) layer function module; and
the second function module comprises at least one function module other than the first function module in the RLC layer function module, the MAC layer function module, and the PHY layer function module.

6. The method according to claim 1, wherein the first function module comprises at least one of a communications function module or a source coding function module; and
the second function module comprises a function module other than the first function module in the communications function module and the source coding function module.

7. A communications apparatus, comprising:
a first function module;
a second function module;
a first agent configured in the first function module; and
a second agent configured in the second function module, wherein
the first agent comprises:
a communications interface configured to obtain related information of the second agent; and
a processing circuit configured to make a decision on the first function module based on the related information of the second agent.

8. The apparatus according to claim 7, wherein the related information of the second agent comprises at least one of the following information:
a first evaluation parameter made by the second agent for a historical decision of the first agent, a historical decision of the second agent, a neural network parameter of the second agent, or an update gradient of the neural network parameter of the second agent.

9. The apparatus according to claim 7, wherein the processing circuit is configured to make the decision on the first function module based on at least one of related information of the first function module or related information of the second function module, and the related information of the second agent.

10. The apparatus according to claim 9, wherein:
the related information of the first function module comprises at least one of the following information: current environment status information of the first function module, predicted environment status information of the first function module, or a second evaluation parameter made by the first function module for the historical decision of the first agent; and
the related information of the second function module comprises at least one of current environment status information of the second function module or predicted environment status information of the second function module.

11. The apparatus according to claim 7, wherein the first function module comprises at least one of a radio link control (RLC) layer function module, a medium access control (MAC) layer function module, or a physical (PHY) layer function module; and
the second function module comprises at least one function module other than the first function module in the RLC layer function module, the MAC layer function module, and the PHY layer function module.

12. The apparatus according to claim 7, wherein:
the first function module comprises at least one of a communications function module or a source coding function module; and
the second function module comprises a function module other than the first function module in the communications function module and the source coding function module.

13. A non-transitory computer-readable storage medium applied to a communications system, the communications system comprising at least two function modules, the at least two function modules comprising a first function module configured with a first agent and a second function module configured with a second agent, wherein the computer-readable storage medium stores program instructions, and when the program instructions are run by a processor, the operations implemented by the communications system comprises:
obtaining, by the first agent, related information of the second agent; and
making, by the first agent, a decision on the first function module based on the related information of the second agent.

14. The non-transitory computer-readable storage medium according to claim 13, wherein the related information of the second agent comprises at least one of the following information:
a first evaluation parameter made by the second agent for a historical decision of the first agent,
a historical decision of the second agent,
a neural network parameter of the second agent, or
an update gradient of the neural network parameter of the second agent.

15. The non-transitory computer-readable storage medium according to claim 13, wherein the making, by the first agent, the decision on the first function module based on the related information of the second agent comprises:
making, by the first agent, the decision on the first function module based on at least one of related information of the first function module or related information of the second function module; and
the related information of the second agent.

16. The non-transitory computer-readable storage medium according to claim 15, wherein:
the related information of the first function module comprises at least one of the following information: current environment status information of the first function module,
predicted environment status information of the first function module, or
a second evaluation parameter made by the first function module for the historical decision of the first agent; and
the related information of the second function module comprises at least one of current environment status information of the second function module or predicted environment status information of the second function module.

17. The non-transitory computer-readable storage medium according to claim 13, wherein
the first function module comprises one of a radio link control (RLC) layer function module, a medium access control (MAC) layer function module, and a physical (PHY) layer function module; and
the second function module comprises at least one function module other than the first function module in the RLC layer function module, the MAC layer function module, and the PHY layer function module.

18. The non-transitory computer-readable storage medium according to claim 13, wherein the first function module comprises at least one of a communications function module or a source coding function module; and
the second function module comprises a function module other than the first function module in the communications function module and the source coding function module.
